(19) United States
(12) Patent Application Publication
(10) Pub. No.: US 2012/0325763 A1
(43) Pub. Date: Dec. 27, 2012

(54) FLIP-DOWN GRAPHIC SHELF DISPLAY AND SHELVING UNIT INCORPORATING THE SAME

(75) Inventors: Kenneth E. Loy, Louisville, OH (US); Randy J. Rohr, Canal Fulton, OH (US)

(73) Assignee: E-B DISPLAY COMPANY, INC., Massillon, OH (US)

(21) Appl. No.: 13/224,919

(22) Filed: Sep. 2, 2011

Related U.S. Application Data
(60) Provisional application No. 61/501,403, filed on Jun. 27, 2011.

(51) Int. Cl. A47B 96/02; A47B 96/07; G09F 15/00; F16B 2/20; G09F 15/02

(52) U.S. Cl. 211/134; 24/530; 24/500; 40/606.01; 248/291.1

(57) ABSTRACT

A latching assembly for a graphic shelf display and a shelving unit incorporating the same. The display includes a support plate, a front panel, and a hinge securing them together so that the panel can pivot between an upright position and a flipped-down position. The latching assembly includes a spring clip on the panel and a latch member on the support plate. The spring clip is fixed at a first end to a spring clip housing on the panel and the second end thereof is free to pivot in a first direction to engage the latch member and in a second direction to disengage therefrom. A detent extending outwardly from the spring clip is received in aligned slots in the housing and latch member when the latching assembly is engaged. A graphics card is retained in a channel on the outer surface of the panel.

### CROSS-REFERENCE TO RELATED APPLICATION

This application claims priority from U.S. Provisional Application Ser. No. 61/501,403, filed Jun. 27, 2011, the disclosure of which is incorporated herein by reference.

### BACKGROUND OF THE INVENTION

1. Technical Field

This invention generally relates to product displays. More particularly, the invention relates to a shelving unit for displaying products in a big box store. Specifically, the invention relates to a flip-down for a front end of a shelf which is movable between an upright position and a flipped-down position and has provision for receiving graphics on a front face thereof.

2. Background Information

Display shelving typically is constructed from vertical metal posts that have a plurality of locations at which grid-type shelving may be secured. One of the problems with this type of shelving is it is difficult to display product information and pricing on the same. Additionally, the shelving typically lacks a front lip to prevent products retained thereon from rolling off the shelf. Putting lips on this type of shelving creates problems for store employees who may have to pull cut boxes or other display containers from the shelf in order to restock the same.

There is therefore a need in the art for a product that addresses these shortcomings of the typical shelving displays utilized in big box stores.

### BRIEF SUMMARY OF THE INVENTION

The device of the present invention comprises a latching assembly for a graphic shelf display and a shelving unit incorporating the same. The display includes a support plate, a front panel, and a hinge securing them together so that the panel can pivot between an upright position and a flipped-down position. The latching assembly includes a spring clip on the panel and a latch member on the support plate. The spring clip is fixed at a first end to a spring clip housing on the panel and the second end thereof is free to pivot in a first direction to engage the latch member and in a second direction to disengage therefrom. A detent extending outwardly from the spring clip is received in aligned slots in the housing and latch member when the latching assembly is engaged. A graphics card is retained in a channel on the outer surface of the panel.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a front perspective view of a shelving unit incorporating the flip-down graphic shelf display in accordance with the present invention;

FIG. 2 is a rear perspective view of the graphic shelf display shown apart from the shelving unit;

FIG. 3A is an exploded rear perspective view of a first portion of the graphic shelf display of FIG. 2;

FIG. 3B is an exploded rear perspective view of a second portion of the graphic shelf display of FIG. 2;

FIG. 4 is a rear view of the a region of the graphic shelf display taken through line 4-4 of FIG. 2, showing the spring clip assembly and channel keeper in greater detail and when the graphic channel is in the upright position;

FIG. 5 is a cross-sectional side view of the graphic shelf display shown secured to the shelving unit and in the flipped-down position;

FIG. 6 is a cross-sectional side view of the graphic shelf display shown part way between the flipped-down position and the upright position;

FIG. 7 is a cross-sectional side view of the graphic shelf display shown in the upright position;

FIG. 8 is a rear view of the region of the graphic shelf display shown in FIG. 4 but showing the snap detent being disengaged from the spring clip; and

FIG. 9 is a cross-sectional side view showing the positions and movement of the snap detent after disengagement from the spring clip.

Similar numbers refer to similar parts throughout the drawings.

### DETAILED DESCRIPTION OF THE INVENTION

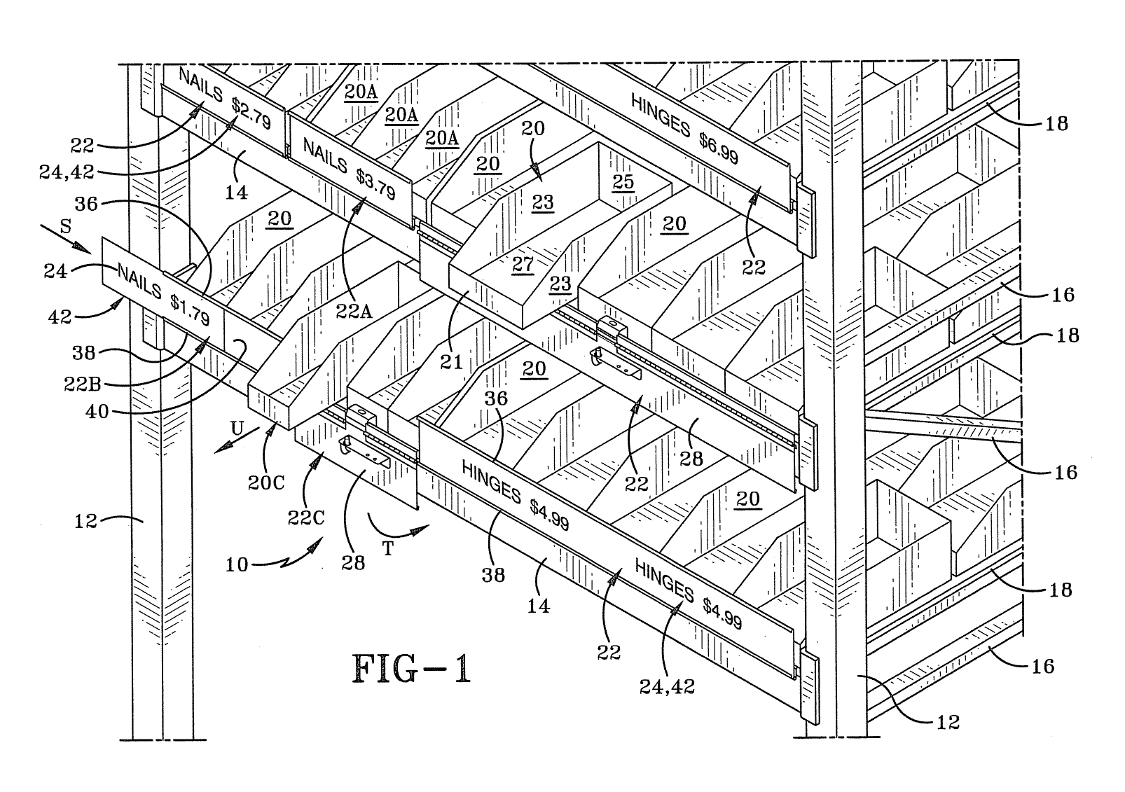

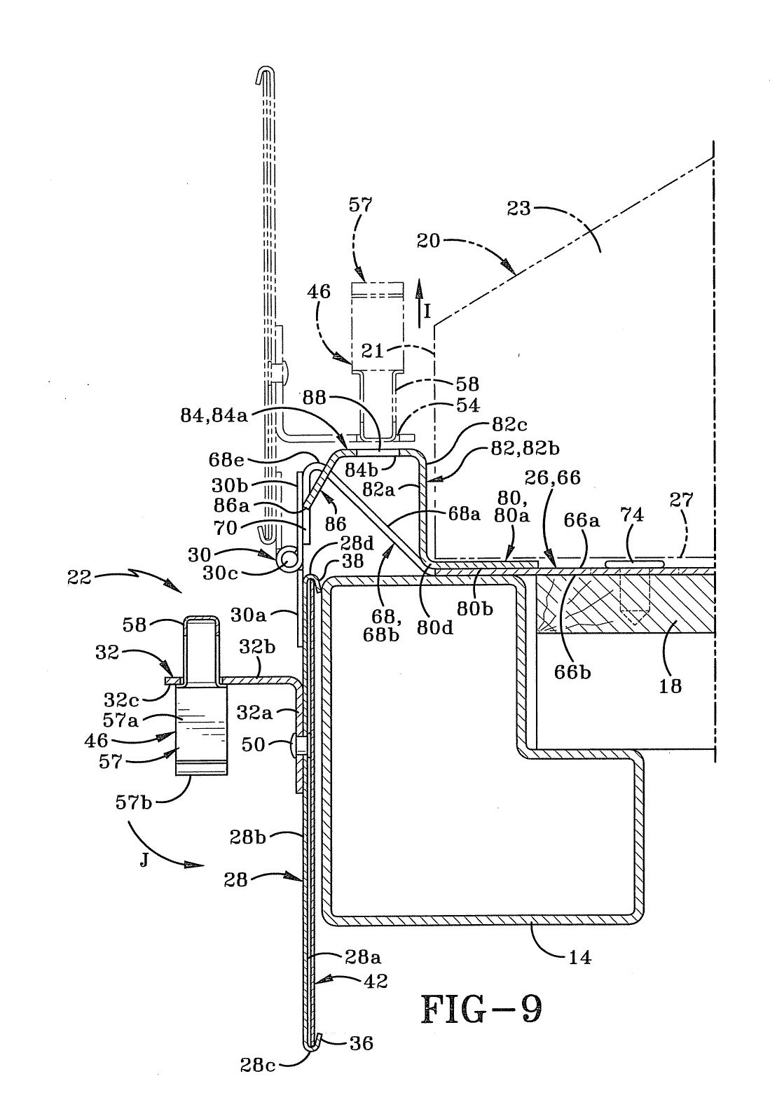

Referring to FIGS. 1-9, there is shown a portion of a shelving unit 10 comprising a plurality of vertical posts 12, horizontal supports 14, and cross-bracing 16 which secures posts 12 together. A plurality of grid-type shelves 18 are supported on horizontal supports 14 and are spaced at vertical intervals from each other. The number and position of shelves 18 may be readily adjusted within unit 10. Shelves 18 are configured to receive a plurality of products 20 thereon. Products 20 may be individually placed on shelves 18 or, if relatively small, may be retained in containers that are placed on shelves 18. Reference character 20 should be understood to represent either individual products for sale or the containers that retain those products.

In accordance with the present invention, shelving unit 10 includes flip-down graphic shelf displays, generally indicated at 22. Graphic shelf displays 22 are movable between an upright position and a flipped-down position. When in the upright position, graphic shelf displays 22 are useful for retaining products 20 on shelves 18. Additionally, when in the upright position, graphic images 24 on the outer surface of graphic shelf displays 22 are visible to potential consumers. When graphic shelf display 22 is in the flipped-down position, graphic images 24 are no longer visible to potential consumers but the products 20 may be readily slid off shelves 18.

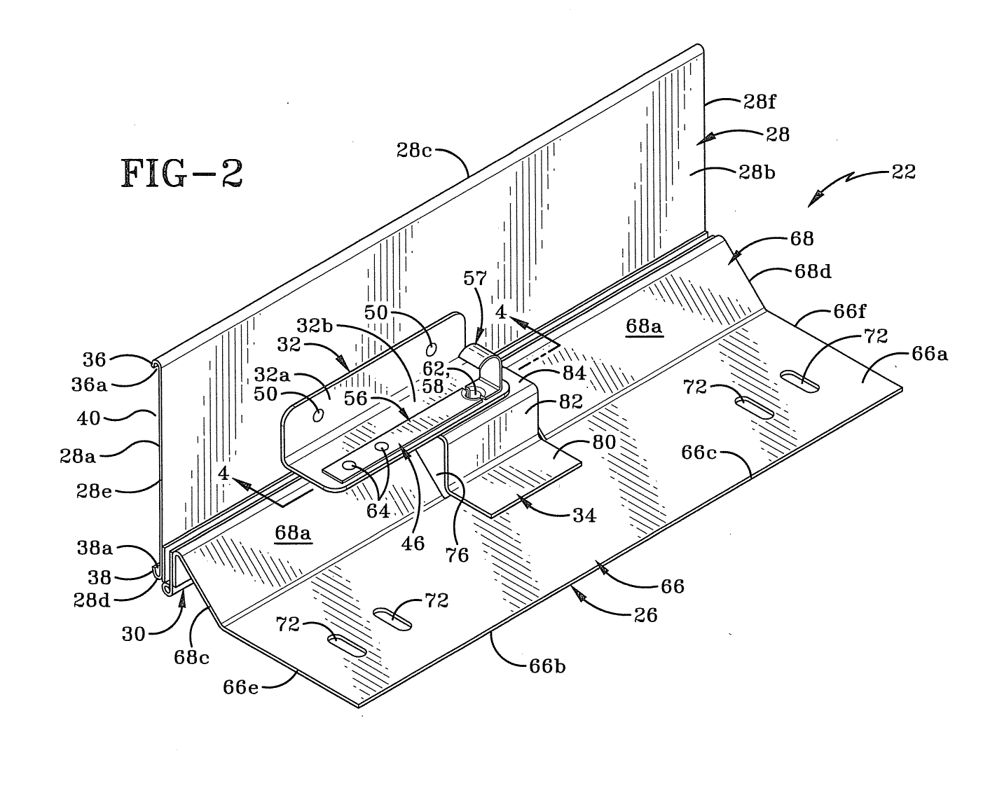

FIGS. 2-4 show graphic shelf display 22 in greater detail. Graphic shelf display comprises a support plate 26, a front panel 28, a hinge 30 securing support plate 26 and front panel 28 together, a spring clip housing 32, and a latch member 34.

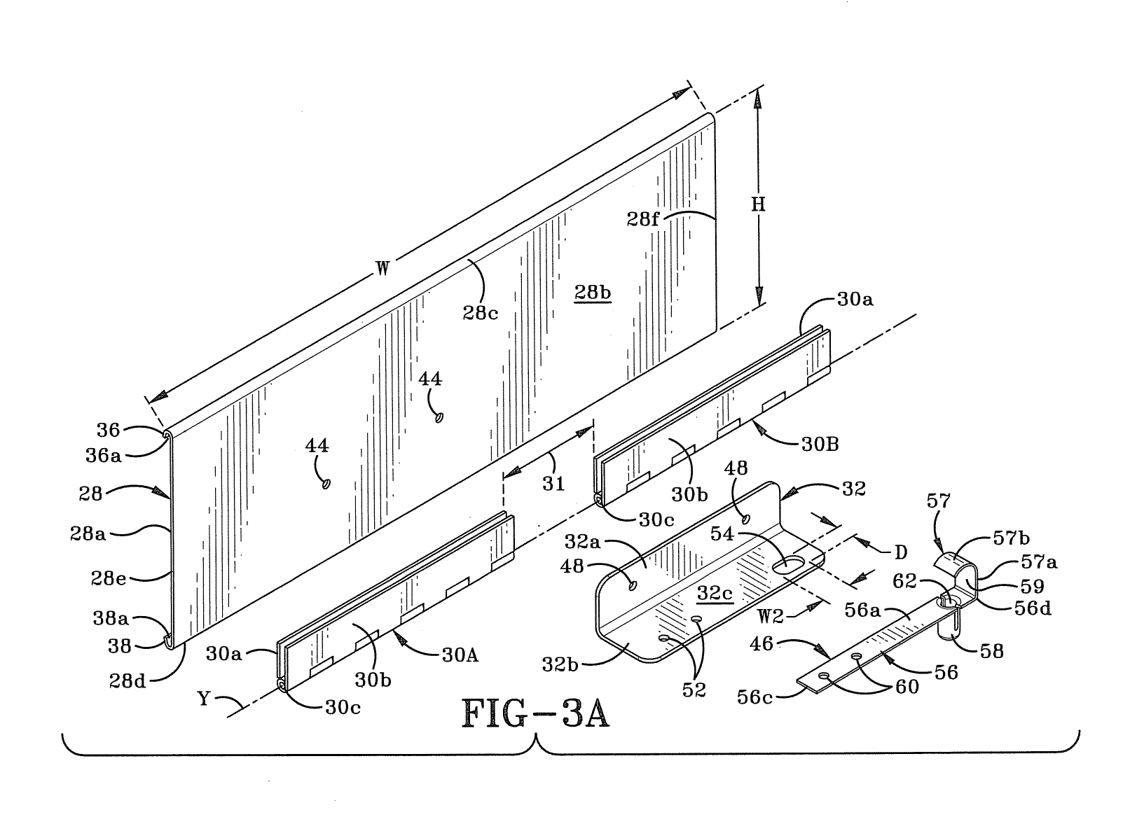

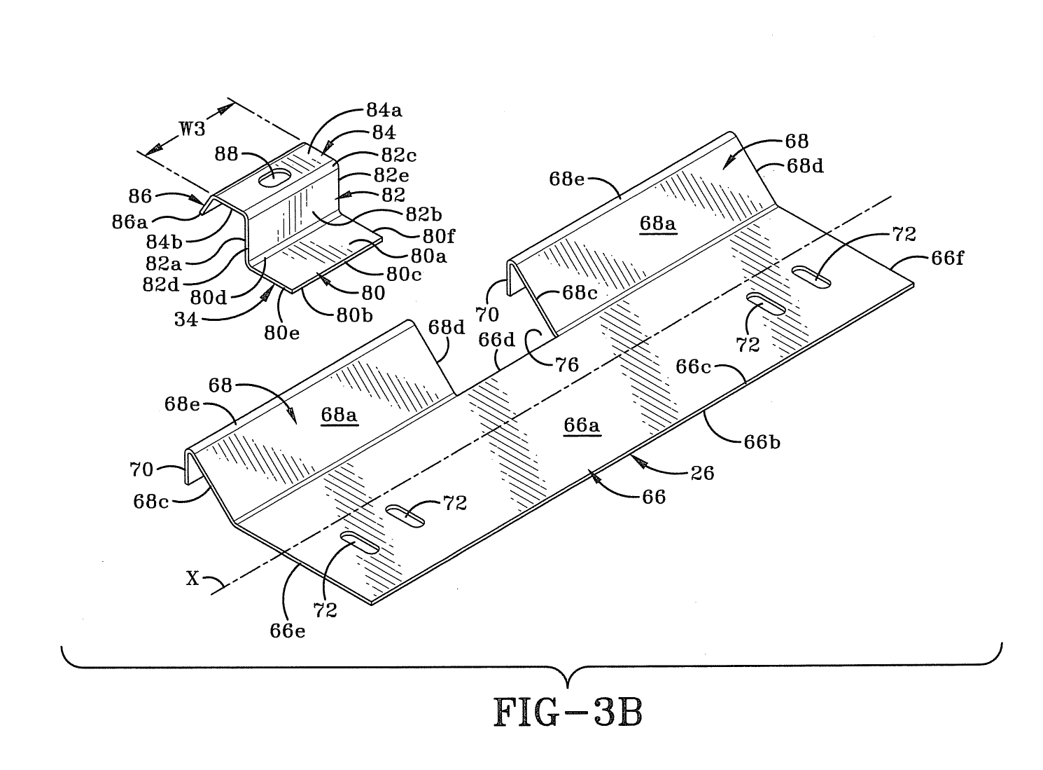

Referring to FIG. 3A, front panel 28 comprises a planar member having an outer surface 28a, an inner surface 28b, a top end 28c, a bottom end 28d, a first side edge 28e and a second side edge 28f. Front panel 28 is generally rectangular in shape and has a of width “W” as measured between first and second side edges 28e, 28f, and has a height “H” as measured between top and bottom ends 28c, 28d. Preferably, the width “W” is one of 12 inches long or 37 inches long. This enables the installer to utilize a single graphic shelf display 22 on the front of a shelf 18 of shelving unit 10. Alternatively, the installer can utilize several graphic shelf displays 22 alongside each other and along the front of shelf 18. It will be understood that any other suitable width front panels 28 may be used without departing from the scope of the present invention. Preferably, the height “H” of front panel 28 is around 4% inches. It will be understood, however, that other suitable height front panels may be utilized without departing from the scope of the present invention.

In accordance with a specific feature of the invention, front panel 28 has a curved upper lip 36 at top end 28c and has a curved lower lip 38 at bottom end 28d. Upper and lower lips 36, 38 curve toward each other and form a groove 36a, 38a between lips 36, 38 and outer surface 28a of front panel 28. Grooves 36a, 38a and front surface 28a define a channel 40 (FIG. 1) that is configured to receive and retain a graphic's card 42 adjacent front surface 28a. Graphic images 24 preferably are applied to graphic's card 42 so that the cards may be readily slit into and out of channel 40 as products on the shelf 18 change. A pair of spaced apart apertures 44 are defined in front panel 28. Apertures 44 are horizontally spaced apart from each other and extend from front surface 28a through to back surface 28b thereof.

In accordance with yet another feature of the present invention, one or more hinges 30 are provided to secure front panel 28 to support plate 26. The number of hinges 30 utilized depends on the overall width “W” of front panel 28 and its associated support plate 26. Preferably, each hinge 30 is a piano hinge that includes a first member 30a that is secured by a suitable means to front panel 28, and a second member 30b that is secured by a suitable means to support plate 26. Hinge 30 is provided to permit front panel 28 to pivot relative to support plate 26 about a longitudinal axis “Y” which extends through spine 30c of hinge 30. Preferably, at least two hinges 30 are provided on each graphic shelf display 22. Hinges 30A and 30B (FIG. 3A) are separated from each other by a gap 31, the purpose of which will be described later herein. Hinges 30 permit front panel 28 to be pivoted relative to support plate 26 from an upright position where front panel 28 is disposed at 90° relative to support plate 26 and a flipped-down position where front panel is disposed at 270° relative to support plate 26.

In accordance with another feature of the present invention, a spring clip housing 32 is provided to mount a spring clip 46 to front panel 28. Spring clip housing 32 comprises a generally L-shaped member having a first leg 32a and a second leg 32b that are disposed generally at right angles to each other. First leg 32a defines a pair of spaced apart holes 48 therein that extend between an inner and outer surface of first leg 32a. The spacing between holes 48 corresponds to the spacing between apertures 44 on front panel 28. Spring clip housing 32 is positioned on front panel 28 so that outer surface of first leg 32a abuts inner surface 28b of front panel 28. Fasteners 50 extend through the aligned holes 48 and apertures 44 to secure spring clip housing 32 to front panel 28. Suitable fasteners 50 for this purpose include rivets and bolts, although rivets are preferred because they will not extend beyond front surface 28a of front panel 28 and thereby interfere in channel 40.

Second leg 32b of spring clip housing 32 defines a pair of relatively closely spaced holes 52 therein and a slot 54 that a spaced a distance from holes 52. All of holes 52 and slot 54 extend between the inner and outer surfaces of second leg 32b. Slot 54 preferably is generally elliptical in shape.

In accordance with yet another feature of the present invention, spring clip 46 is engageable with spring clip housing 32. Spring clip 46 comprises an elongate base 56 and a hook member 57. Base 56 is elongate and planar and has an outer surface 56a and an inner surface 56b. Hook member 57 preferably is integrally formed with base 56 and includes a vertical section 57a and a hooked region 57b. Hooked region 57b is disposed generally at right angles to outer surface 56a. Hooked region 57b extends outwardly away from vertical section 57a and includes a concave curve that extends back over base 56 and arches somewhat downwardly toward base. The curvature of hooked region 57b is gentle. It will be understood that hooked region 57b does not need to be curved but could, instead, simply be a planar region that extends outwardly from vertical section 57a and at right angles thereto. Hooked region 57b is separated from base 56 by a gap 59 that is sufficiently large enough for a user to insert a fingertip therein so that they can grasp hooked region 57b.

A pair of spaced apart apertures 60 is defined between the inner and outer surfaces of 56 and apertures 60 extend between outer and inner surfaces 56a, 56b thereof. The spacing between apertures 60 is complementary to the spacing between holes 52 in spring clip housing 32. It should further be noted that apertures 60 are defined proximate a first end 56c of base 56. A third aperture 62 is defined in base 56 a spaced distance from apertures 60 and proximate hook member 57. The positioning of third aperture 62 is complementary to the location of slot 54 in spring clip housing 32. Third aperture 62 is configured to receive an end region of a detent 58 therethrough. Detent 58 is suitably attached to base 56 and the body of detent 58 projects outwardly away from the inner surface 56b of base 56 and in an opposite direction to vertical section 57a of hook member 57.

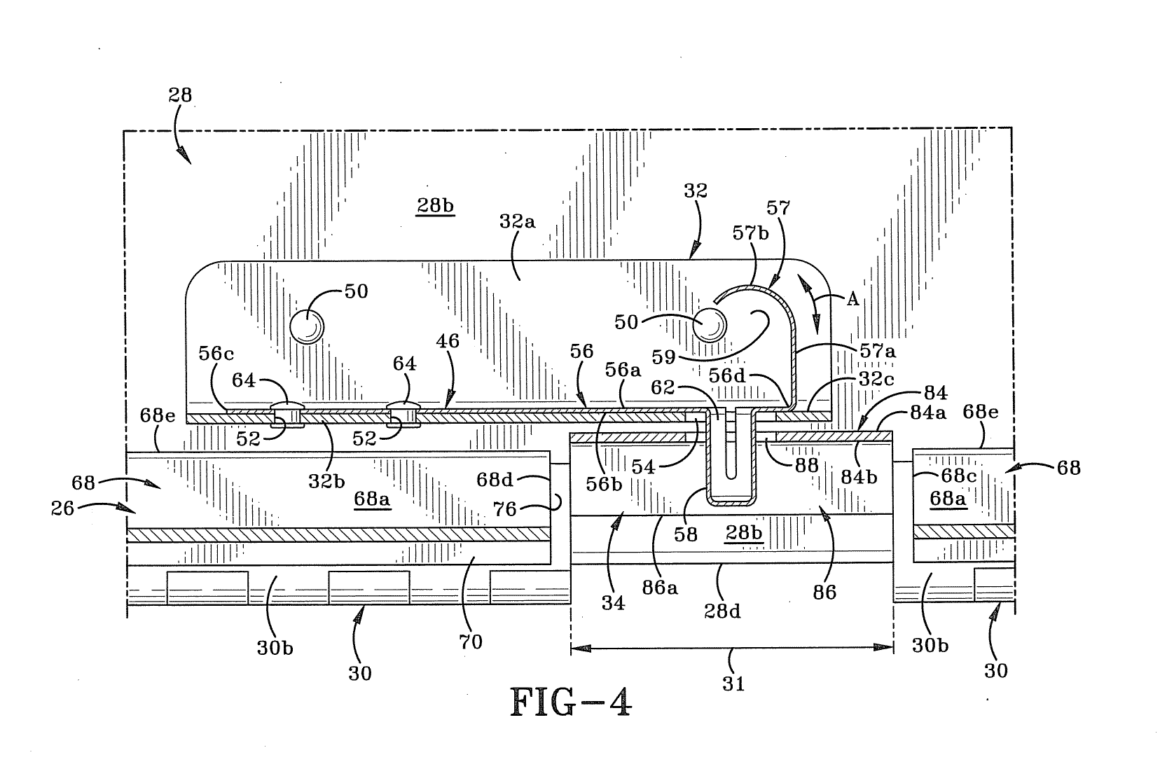

Spring clip 46 is engaged with spring clip housing 32 by placing inner surface 56b of spring clip 46 adjacent outer surface 32c of spring clip housing 32 and in such a manner that detent 58 on spring clip 46 is received through slot 54 in spring clip housing 32. Fasteners 64, such as rivets, are inserted through aligned apertures 60 and holes 52. It should be noted that the only location on spring clip 46 where it is fixedly secured to spring clip housing 32 is adjacent first end 56c. This means that second end 56d (FIG. 4) is free of permanent attachment to spring clip housing 32. This makes it possible for second end 56d to be moved upwardly and downwardly in the directions indication by arrow “A” (FIG. 4) during operation of the graphic shelf display 22. As is evident from FIG. 3A, slot 54 is substantially elliptical in shape while detent 58 is cylindrical in cross-sectional shape. The diameter of detent 58 is slightly smaller than the depth “D” (FIG. 3A) of slot 54. Additionally, the diameter of detent 58 is smaller than the width “W2” of slot 54. This difference in shape and size between slot 54 and detent 58 makes it possible for detent 58 to be pivoted into and out of slot 54 in the directions indicated by arrow “A” (FIG. 4) as will be later described herein.

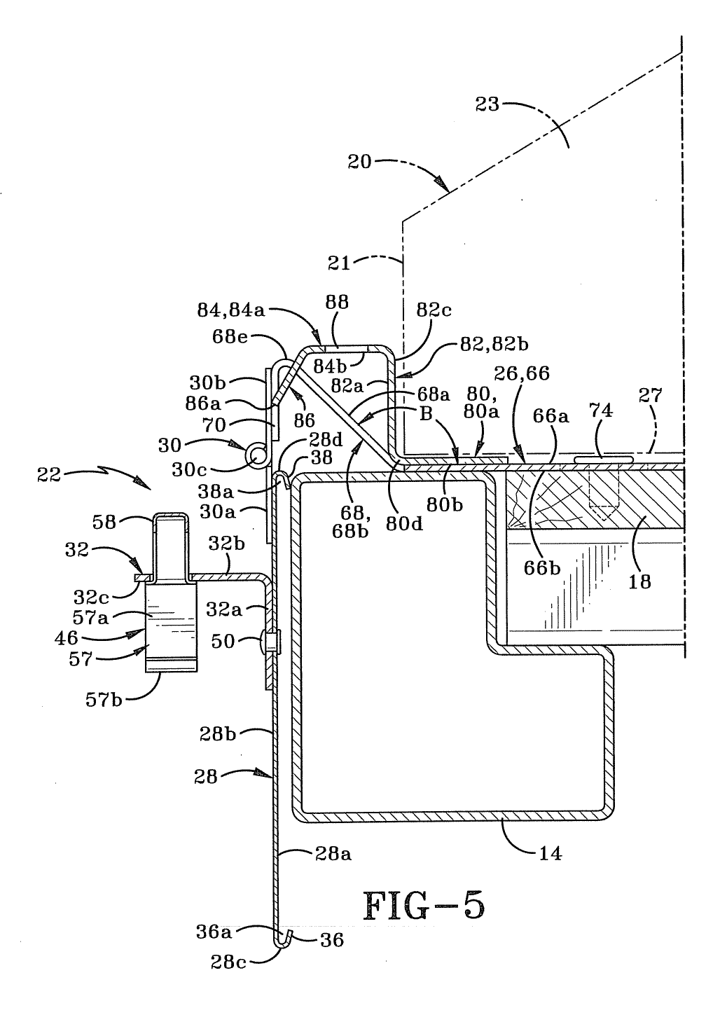

Referring now to FIG. 3B, there is shown support plate 26 and latch member 34 in greater detail. Support plate 26 comprises a first planar region 66, a pair of second planar regions 68 and a pair of flanges 70. First planar region 66 has an outer surface 66a and an inner surface 66b (FIG. 5), a first end 66c, a second end 66d and opposed sides 66e, 66f. A plurality of elliptical slots 72 are defined in first planar region 66. Each slot 72 extends between outer and inner surfaces 66a, 66b of first planar region 66 and is generally disposed at right angles to longitudinal axis “X” thereof. Preferably, slots 72 are disposed in pairs and the pairs are spaced longitudinally from each other. Still further, at least one pair of slots 72 is disposed adjacent a first side 66e of first planar region 66 and another pair of slots 72 is disposed adjacent a second side 66f of first planar region 66. Slots 72 are configured to receive fasteners 74 (FIG. 5) therethrough. Fasteners 74 secure first planar region 66 of support plate 26 to the wood or metal of shelf 18.

As indicated above, support plate 26 further includes a pair of second planar regions 68. Second planar regions 68 are integrally formed with second end 66d of first planar region 68 and extend outwardly away therefrom. Second planar regions 68 are each disposed at an angle relative to outer surface 66a of first planar region 66. Preferably that angle, “B” (FIG. 5) preferably is around 135°. Each second planar region 68 has an outer surface 68a, an inner surface 68b, a first side edge 68c, a second side edge 68d and a longitudinal edge 68e. A gap 76 is defined between the two second planar regions 68 and between the second side edge 68d of a first one of the second planar regions 68 and the first side edge 68c of the second one of the second planar regions 68.

A flange 70 extends outwardly from the longitudinal edge 68e of each of second planar regions 68. Flange 70 is disposed at an angle “C” relative to second planar region 68 and that angle is around 45° relative to inner surface 68b. Flange 70 is shorter than the distance between outer surface 66a of first planar region 66 and longitudinal edge 68e of second planar region.

Still referring to FIG. 3B, there is shown the latch member 34 in accordance with the present invention. Latch member 34 includes a first arm 80, a second arm 82, a third arm 84, and a fourth arm 86. First arm 80 is generally rectangular in shape and is planar and includes an outer surface 80a, inner surface 80b (FIG. 5), first longitudinal edge 80c, second longitudinal edge 80d, first side edge 80e, and second side edge 80f. First arm 80 has a width “W3” as measured between first and second side edges 80e, 80f and this width “W3” is substantially the same size as gap 76 in support plate 26. Latch member 34 is positioned on support plate 26 in such a manner that inner surface 80b of first arm abuts outer surface 66a of first planar region 66. Second arm 82, third arm 84 and fourth arm 86 projects forwardly away from second longitudinal edge 80d of first arm 80 and into gap 76 between second planar regions 68.

Second arm 82 extends outwardly and upwardly from second longitudinal edge 80d and is disposed generally at right angles to outer surface 80a of first arm 80. Second arm 82 is planar and generally rectangular in shape and has an outer surface 82a, an inner surface 82b (FIG. 5), a first longitudinal edge 82c, and first and second side edges 82d, 82e.

Third arm 84 extends outwardly and horizontally from first longitudinal edge 82c of second arm. Third arm 84 is planar and generally rectangular in shape and includes an outer surface 84a, an inner surface 84b (FIG. 5), a first longitudinal edge 84c, a first side edge 84d and a second side edge 84e. A slot 88 is defined in third arm 84 and extends from outer surface 84a through to inner surface 84b thereof. Slot 89 is of substantially the same size and shape as slot 54 in spring clip housing 32 and is configured to be selectively aligned therewith as is illustrated in FIG. 4.

Finally, latch member 34 includes fourth arm 84 that extends outwardly away from first longitudinal edge 82c of third arm 82. Although not specifically illustrated herein, it should be understood that fourth arm 84 is a planar, generally rectangular member that is disposed at an angle relative to outer surface 84a of third arm. That angle “C” (FIG. 5) is around 30°. It should be noted that second, third and fourth arms 82, 84, 86 are not fixedly secured to any components other than first arm 80. Furthermore, the configuration of latch member 34 is such that it presents a face, namely fourth arm 86, for detent 58 to ride along when front panel 28 is moved from a flipped-down position to an upright position as will be further described.

Referring to FIGS. 1-8, graphic shelf display assembly 22 is used in the following manner. FIG. 1 shows shelving unit 10 having a plurality of shelves 18 that include cut boxes 20 for display of products (not shown) therein. Each cut box 20 has a front wall 21 that is substantially shorter than the side walls 23 or rear wall 25. Each cut box 20 defines an interior chamber 27 which is suitable for retaining a plurality of products for sale therein. Since front wall 21 is so much shorter than the other walls 23, 25 of box 20, the products retained therein could easily drop out of chamber 27 of box 20 and onto the shelf 18 or floor (not shown). This type of box 20 makes it relatively easy for a consumer to access the products they want to purchase but does increase the likelihood that some of those products will spill out of box 20. Graphic shelf display assembly 22A is therefore moved into an upright position, such as is shown with graphic shelf display assembly 22A. Display assembly 22A helps retain products inside the chamber of box 20A behind display assembly 22A. Display assembly 22A also provides an excellent vehicle for providing product information and pricing. The graphic indicia 24 relating to this information may be written directly onto outer surface 28a of front panel 28 or the indicia may be written or printed onto cardstock. That graphics card 42 may be inserted into channel 40 on outer surface 28a of display assembly 22B as shown by the direction arrow “S” in FIG. 1.

FIG. 1 also shows a third display assembly 22C where the front panel 28 thereof has been flipped down in the direction of arrow “T” by a store employee who now has ready access to box 20C behind the same. That box 20C can be pulled forwardly in the direction of arrow “U” off a portion of the shelf so that it can be easily restocked. When the restocking has occurred, the box 20C is pushed back onto shelf 18 in the opposite direction of arrow “A” and display assembly 22C is rotated into the upright position by pivoting it in the opposite direction to arrow

FIG. 5 illustrates display assembly 22C when in the flipped-down or first position. In this position, front panel 28 hangs downwardly from hinge 30 and is generally parallel to first and second members 30a, 30b of hinge 30. Additionally, front panel 28 is substantially at right angles relative to first planar region 66 of support plate 26. Additionally, detent 58 points upwardly and hook member 57 hangs downwardly from spring clip housing 32.

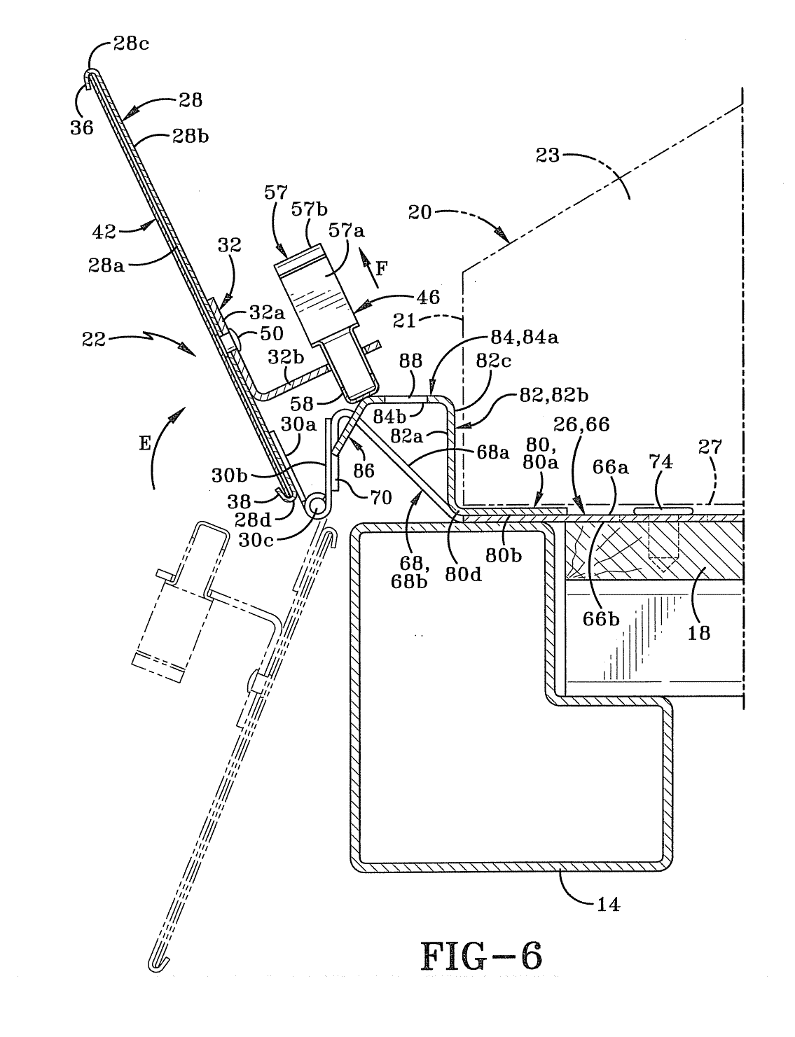

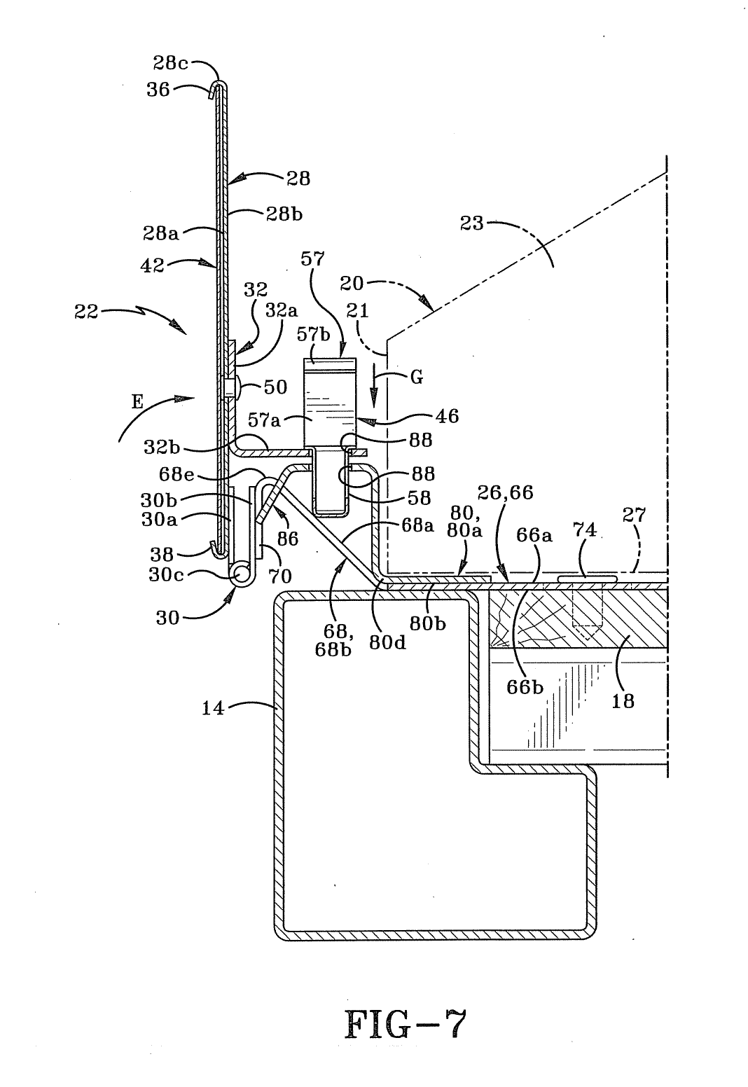

In order to move front panel 28 from the flipped down first position to the upright second position, the user pivots front panel 28 in the direction of arrow “E” (FIG. 6). This motion brings detent 58 into contact with fourth arm 86 of latch member 34. Detent 58 rides along the angled slope of fourth arm 86 and is pushed upwardly in the direction of arrow “F” and then onto outer surface 84a of third arm 84. When detent 58 reaches slot 88 in third arm 84, detent 58 slips downwardly in the direction of arrow “G” through slot 88 therein, thereby latching front panel 28 and latch member 34 together (FIG. 7). When in this latched position, detent 58 extends through the aligned slots 54 and 88 and cannot be accidentally dislodged therefrom because the spring bias of spring clip 46 keeps detent 58 urged toward third arm 84. In this position, further rotational motion to move the front panel 28 toward the flipped down first position is not possible additionally, rotational motion in the opposite direction is also prevented as is lateral motion.

FIG. 7 shows that front panel 28 in this upright position substantially prevents box 20 from being slid off front of shelf 18. Additionally, the front panel 28 extends for a distance vertically above front wall 21 of cut box 20, thereby ensuring that any product in cut box 20 is retained therein unless the consumer lifts such a product over top end 28c of front panel 28. Additionally, front panel 28 is positioned vertically and generally at right angles to outer surface 66a of support panel 26. Vertically oriented front panel 28 extends for a distance beyond the upper edge of front wall 21 of box 20. Additionally, when front panel 28 is in this second position, it should be noted that front panel 28 is disposed at 180° relative to its first position.

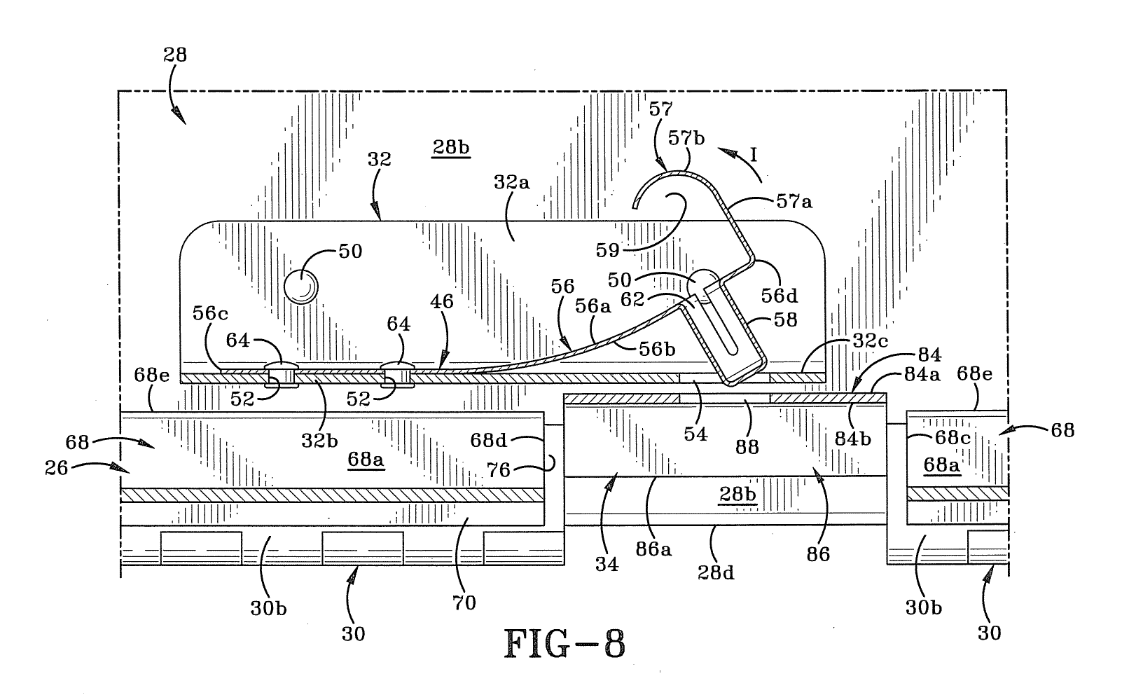

FIG. 8 shows the instance when an employee or other authorized personnel wants to gain direct access to box 20 in order to slide it off shelf 18 or pull it part the way off shelf 18, that person needs to unlatch front panel 28 from latch member 34. This is accomplished by slipping a fingertip into hooked portion 57b of spring clip 46 and pulling the same upwardly in the direction of arrow “I”. This motion pulls detent 58 out of the aligned apertures 88, 54 and leaves front panel 28 free to be pivoted out of the way, Front panel 28 can then be partially rotated to a position sufficient that detent 58 clears aperture 54 and rests on angled fourth arm 86 of latch member 34. The user can then simply let front panel 28 rotate downwardly in the direction of arrow “J” and back into the first position where it hangs downwardly from hinge 30. In its resting position, where front panel 28 hangs vertically downwardly, front panel 28 is disposed substantially at right angles to outer surface 66a and the user can easily gain access to box 20.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A graphic shelf display for a shelving unit comprising;
a support plate adapted to be detachably secured to a front of shelf of the shelving unit;
a front panel;
a hinge securing the front panel to the support plate, wherein the front panel is pivotable between a first position and a second position, and when in the first position the front panel is disposed at 90° relative to the support plate and extends in a first direction upwardly therefrom; and when in the second position, the front panel is disposed at 270° relative to the support plate and extends in a second direction therefrom; and
a latching assembly movable between an engaged position and a disengaged position, and when the latching assembly is in the engaged position it retains the front panel in the first position and prevents the front panel from pivoting, and when the latching assembly is in the disengaged position the front panel is free to pivot.

2. The graphic shelf display as defined in claim 1, wherein the latching assembly comprises:
a spring clip assembly secured to the front panel; and
a latch member secured to the support panel; and wherein the spring clip assembly is selectively engaged with the latch member to retain the front panel in the first position.

3. The graphic shelf display as defined in claim 2, wherein the spring clip assembly comprises:
a spring clip housing fixedly secured to the front panel; and
a spring clip engaged with the spring clip housing, the spring clip being movable between a first position and a second position, and when the spring clips is in the first position, it interlocking engages the latch member on the support panel; and when in the second position, the spring clip is free of engagement with the latch member.

4. The graphic shelf display as defined in claim 3, wherein the spring clip comprises:
a base having an outer surface, an inner surface, a first end and a second end, and wherein the base has a longitudinal axis extending between the first and second ends thereof;
a fastener fixedly securing the first end of the base to the spring clip housing; and
a detent extending outwardly from the inner surface of the base and proximate the second end thereof; the detent being disposed generally at right angles to longitudinal axis of the base; and wherein the second end of the base is free of attachments to the spring clip housing.

5. The graphic shelf display as defined in claim 4, wherein the spring clip further comprises:
a hook member extending outwardly from the outer surface of the base and proximate the second end thereof, the hook member including;
a first leg extending outwardly from the outer surface of the base and disposed generally at right angles to the longitudinal axis of the base; and
a hooked region extending outwardly from the first leg and generally toward the first end of the base.

6. The graphic shelf display as defined in claim 5, wherein the hooked region curves in a direction toward the outer surface of the base.

7. The graphic shelf display as defined in claim 4, wherein the spring clip housing includes:
a first leg fixedly secured to an inner surface of the front panel;
a second leg extending outwardly from the first leg and at an angle relative to the inner surface of the front panel; and
a slot defined in the second leg, wherein the first end of the base is fixedly secured to the second leg of the spring clip housing and the detent of the spring clip extends through the slot in the second leg thereof.

8. The graphic shelf display as defined in claim 7, wherein the second end of the spring clip is movable toward the second leg of the spring clip housing when the latching assembly is engaged and is movable away from the second leg when the latching assembly is disengaged.

9. The graphic shelf display as defined in claim 8, wherein the detent is generally cylindrical in shape and has a first end disposed adjacent the inner surface of the base and a second end remote therefrom; and wherein the detent has a cross-sectional diameter; and wherein the slot in the second leg of the spring clip housing is generally elliptical in shape and has a length and a width, and wherein the width of the slot is at least a wide as the diameter of the detent, and the length of the slot is substantially longer than the diameter of the detent.

10. The graphic shelf display as defined in claim 9, wherein the second end of the spring clip pivots relative to the second leg of the spring clip housing when the latching assembly is engaged or disengaged, and when the second end of the spring clip pivots in a first direction, the detent moves into the slot in the second leg of the spring clip housing, and when the second end of the spring clip pivots in a second direction, the detent moves out of the slot in the second leg of the spring clip housing.

11. The graphic shelf display as defined in claim 10, wherein the latch member includes:
an arm disposed generally parallel to a longitudinal axis of the hinge;
a second slot defined in the arm and extending between an upper and a lower surface thereof; and wherein the second slot is positioned on the arm to align with the slot in the second leg of the spring clip housing when the front panel is moved to the first position; and wherein the detent on the spring clip is received through the aligned slot and second slot when the front panel is in the first position.

12. The graphic shelf display as defined in claim 1, wherein the front panel includes:
an inner surface, an outer surface, a first longitudinal edge, a second longitudinal edge, and first and second sides extending between the first and second longitudinal edges;
a first lip provided along the first longitudinal edge and extending outwardly beyond the inner surface;
a second lip provided along the second longitudinal edge and extending outwardly beyond the inner surface; and
a channel is defined by the first lip, the second lip and the inner surface disposed therebetween, and wherein the channel is adapted to receive a planar sheet containing graphic indicia therein.

13. The graphic shelf display as defined in claim 12, wherein the first lip curves downwardly in a direction toward the second lip and the second lip curves upwardly in a direction toward the first lip.

14. In combination,
a graphic shelf display for a shelving unit comprising;
a support plate adapted to be secured to a shelf of the shelving unit;
a front panel comprising:
an inner surface, an outer surface, a first longitudinal edge, a second longitudinal edge, and first and second sides extending between the first and second longitudinal edges;
a first lip provided along the first longitudinal edge and extending outwardly beyond the inner surface;
a second lip provided along the second longitudinal edge and extending outwardly beyond the inner surface; and
a channel defined by the first lip, the second lip and a portion of the inner surface disposed therebetween;
a hinge securing the front panel to the support plate, wherein the front panel is pivotable between a first position and a second position, and when in the first position the front panel is disposed at 90° relative to the support plate and extends in a first direction upwardly therefrom; and when in the second position, the front panel is disposed at 270° relative to the support plate and extends in a second direction therefrom;
a latching assembly movable between an engaged position and a disengaged position, and when the latching assembly is in the engaged position it retains the front panel in the first position and prevents the front panel from pivoting, and when the latching assembly is in the disengaged position the front panel is free to pivot; and
a planar sheet having a first surface, a second surface and top and bottom edges;
graphic indicia provided on the first surface of the planar sheet; and
wherein the planar sheet is engageable in the channel of the front panel such that the second surface of the planar sheet is adjacent the inner surface of the front panel, and the top edge of the planar sheet is adjacent the first lip, and the bottom edge of the planar sheet is adjacent the second lip.

15. The combination as defined in claim 14, wherein the first lip on the front panel curves downwardly in a direction toward the second lip thereof, and the second lip on the front panel curves upwardly in a direction toward the first lip; and wherein the planar sheet is retained adjacent the inner surface of the front panel by the first and second lips.

16. A shelving unit comprising:
a plurality of vertical posts;
a horizontal shelf extending between the vertical posts and being secured thereto, the shelf having a top surface, a bottom surface, and a front end;
a graphic shelf display selectively secured to the shelf; wherein the graphic shelf display includes:
a support plate that is detachably secured to the top surface of the shelf adjacent the front end thereof;
a front panel;
a hinge securing the front panel to the support plate, wherein the front panel is movable between an upright position where it extends upwardly away from the top surface of the shelf, and a flipped-down position where it extends downwardly away from the top surface of the shelf; and
a latching assembly which releasably retains the front panel in the upright position.

17. A shelving unit as defined in claim 16, wherein the latching assembly comprises:
a spring clip assembly secured to the front panel; and
a latch member secured to the support panel; and wherein the spring clip assembly is selectively engaged with the latch member to retain the front panel in the first position.

18. The shelving unit as defined in claim 17 wherein the spring clip assembly comprises:
a spring clip housing fixedly secured to the front panel; and
a spring clip engaged with the spring clip housing, the spring clip being movable between a first position and a second position, and when the spring clips is in the first position, it interlocking engages the latch member on the support panel; and when in the second position, the spring clip is free of engagement with the latch member.

19. The shelving unit as defined in claim 18, wherein the spring clip comprises:
a base having an outer surface, an inner surface, a first end and a second end, and wherein the base has a longitudinal axis extending between the first and second ends thereof;
a fastener fixedly securing the first end of the base to the spring clip housing; and
a detent extending outwardly from the inner surface of the base and proximate the second end thereof; the detent being disposed generally at right angles to longitudinal axis of the base; and wherein the second end of the base is free of attachments to the spring clip housing.

20. The shelving unit as defined in claim 19, wherein the spring clip further comprises:
a hook member extending outwardly from the outer surface of the base and proximate the second end thereof, the hook member including;
a first leg extending outwardly from the outer surface of the base and disposed generally at right angles to the longitudinal axis of the base; and
a hooked region extending outwardly from the first leg and generally toward the first end of the base.

21. The shelving unit as defined in claim 20, wherein the front panel includes:
an inner surface, an outer surface, a first longitudinal edge, a second longitudinal edge, and first and second sides extending between the first and second longitudinal edges;
a first lip provided along the first longitudinal edge and extending outwardly beyond the inner surface;
a second lip provided along the second longitudinal edge and extending outwardly beyond the inner surface; and
a channel defined by the first lip, the second lip and the inner surface disposed therebetween, and wherein the front panel is adapted to receive a planar sheet having graphic indicia thereon in the channel.

22. A latching assembly for releasably securing a first member and a second member together, the latching assembly comprising:
a spring clip assembly engaged with the first member; and
a latch member engaged with the second member; and wherein the spring clip assembly is selectively engaged with the latch member to retain the first member at right angles to the second member.

23. The latching assembly as defined in claim 22, wherein the spring clip assembly comprises:
a spring clip housing secured to the first member;
a spring clip engaged with the spring clip housing, the spring clip being movable between a first position where it interlocking engages the latch member on the second member; and a second position where it is free of engagement with the latch member.

24. The latching assembly as defined in claim 23, wherein the spring clip comprises:
a base having an outer surface, an inner surface, a first end and a second end, and wherein the base has a longitudinal axis extending between the first and second ends;
a fastener disposed to fixedly secure the first end of the base to the spring clip housing;
a detent extending outwardly from an inner surface of the base proximate the second end thereof; the detent being disposed generally at right angles to longitudinal axis of the base; and wherein the second end of the housing is free of attachments to the spring clip housing.

25. The latching assembly as defined in claim 24, wherein the spring clip further comprises:
a hook member extending outwardly from the second end of the base, the hook member including;
a first leg extending outwardly from the outer surface of the second end of the base, the first leg being disposed generally at right angles to the longitudinal axis of the base; and
a hook member extending outwardly from the first leg and generally toward the first end of the base.

26. The latching assembly as defined in claim 25, wherein the hook member curves in a direction toward the outer surface of the second end of the base.

27. The latching assembly as defined in claim 24, wherein the spring clip housing includes:
a first leg fixedly secured to an inner surface of the first member;
a second leg extending outwardly from the first leg; and
a slot defined in the second leg, and wherein the first end of the base is fixedly secured to the second leg of the spring clip housing and the detent of the spring clip extends through the slot in the second leg of the spring clip housing.

28. The latching assembly as defined in claim 27, wherein the second end of the spring clip pivots relative to the first end thereof when the spring clip is moved between the first and second positions.

29. The latching assembly as defined in claim 28, wherein the detent is generally cylindrical in shape and has a first end disposed adjacent the inner surface of the base and a second end remote therefrom; wherein the detent has a cross-sectional first diameter; and wherein the slot is generally elliptical in shape and has a length and a width, and wherein the width of the slot is at least a wide as the first diameter of the detent, and the length of the slot is substantially longer than the first diameter.

30. The latching assembly as defined in claim 29, wherein the detent pivots into and out of the slot when the spring clip is moved between the first and second positions.

31. The latching assembly as defined in claim 30, wherein the latch member includes:
an arm disposed generally parallel to a longitudinal axis of the hinge;
a second slot defined in the arm and extending between an upper and a lower surface thereof; and wherein the second slot is positioned on the arm to align with the slot in the spring clip housing when the first member is disposed at right angles to the second member; and when the first member is so disposed, the detent on the spring clip is received through the aligned slot and second slot.
